(19) United States
(12) Patent Application Publication
(10) Pub. No.: US 2017/0195929 A1
(43) Pub. Date: Jul. 6, 2017

(54) METHOD AND DEVICE FOR REALIZING AUTOMATIC CALL TRANSFER IN A DUAL SIM DUAL STANDBY MOBILE PHONE

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventor: Zhicheng LI, Beijing (CN)

(21) Appl. No.: 15/242,120

(22) Filed: Aug. 19, 2016

Related U.S. Application Data
(63) Continuation of application No. PCT/CN2016/089179, filed on Jul. 7, 2016.

(30) Foreign Application Priority Data
Dec. 31, 2015 (CN) 201511029872.1

(51) Int. Cl. H04W 36/14; H04W 36/24; H04W 48/10

(52) U.S. Cl. CPC H04W 36/14; H04W 48/10; H04W 36/24; H04W 88/06

(57) ABSTRACT

A method and a device for realizing automatic call transfer in a Dual SIM Dual Standby mobile phone, which relate to monitoring a data storing process of a SIM card of a mobile phone during the operation of the mobile phone; acquiring the type of the first SIM card that functions as a main card currently when a trigger instruction for switching the data storage location is detected; acquiring a signal strength of a network supported by the current first SIM card functioning as a secondary card according to the type of the first SIM card; and judging whether the signal strength of the network is greater than a preset threshold, performing a data storage location switching operation, and setting call transfer for the first SIM card that functions as the secondary card after switching when the signal strength is no greater than the preset threshold.

### CROSS-REFERENCE TO RELATED APPLICATION

This application is a continuation of International PCT Patent Application No. PCT/CN2016/089179, filed Jul. 7, 2016 (attached hereto as an Appendix), and claims benefit/priority of Chinese patent application entitled “METHOD AND DEVICE FOR REALIZING AUTOMATIC CALL TRANSFER IN A DUAL SIM DUAL STANDBY MOBILE PHONE”, application number 201511029872.1, filed with the State Intellectual Property Office of China on Dec. 31, 2015, which are all incorporated herein by reference in entirety.

### TECHNICAL FIELD

The present disclosure relates to the technical field of mobile communications, and in particular, to a method and a device for realizing automatic call transfer in a Dual SIM Dual Standby mobile phone.

### BACKGROUND

With the rapid development of the mobile phone industry and the increasing user demands, Dual SIM Dual Standby mobile phone has become a market trend. Generally, a so-called “Dual SIM Dual Standby” mobile phone has two kinds of chips: one is responsible for operating system application processing; and the other is responsible for baseband signal processing (MODEM). Two mobile phone cards may be inserted into the mobile phone, and a simultaneous standby may be realized. A Dual SIM Dual Standby Dual Active mobile phone has two sets of baseband signal processing chips and may perfectly support the standby of two types of cards; however, in consideration of cost saving, one solution for the current mainstream Dual SIM Dual Standby mobile phone is “Dual SIM Dual Standby Single Active”, that is, only one set of baseband chip is used; it switches between two networks continuously by controlling an IC (chip), and the switching time as well as the switching period is both very short, which is equivalent to Dual Standby from the user's point of view.

Call transfer is a basic network service provided by a mobile communication operator; after a call transfer service has been turned on for a certain phone number or Subscriber Identification Module (SIM) card, a user may set a call transfer condition and a destination number, and all incoming calls that meet the call transfer condition will be transferred to the destination number.

On a Dual SIM Dual Standby Single Active mobile phone, the card on which mobile data is saved is usually the main card, and the other card is a secondary card. For common user demands, call transfer is only set when a SIM card functions as a secondary card, and no call transfer needs to be set when the SIM card functions as a main card. Each time a data card is switched, a manual reset will be required, thereby it has a poor flexibility and a troublesome user operation. Additionally, the existing call transfer solution does not consider the situation of poor call quality; for example, for a mobile phone based on Qualcomm platform, the secondary card can usually only work in a specific mode, for example, when the secondary card is a China Telecom card, no signal may be received; and when the secondary card is a China Unicom card or a China Mobile card, it may only get registered on a 2G network, thus, the signal will be weak, and an incoming call or a message may to be missed.

### SUMMARY

Therefore, it is an object of the present disclosure to put forward a method and a device for realizing automatic call transfer in a Dual SIM Dual Standby mobile phone, thereby the problem in prior art that the call transfer of the main card and the secondary card may only be set manually may can be solved.

Based on the above objects, in the first aspect, an embodiment of the present disclosure provides a method for realizing automatic call transfer in a Dual SIM Dual Standby mobile phone, which includes the steps of:

monitoring a data storing process of a SIM card of a mobile phone during the operation of the mobile phone;

acquiring the type of the first SIM card that functions as a main card currently when a trigger instruction for switching the data storage location is detected;

acquiring a signal strength of a network supported by the current first SIM card functioning as a secondary card according to the type of the first SIM card; and

judging whether the signal strength of the network supported by the current first SIM card functioning as the secondary card is greater than a preset threshold, performing a data storage location switching operation, and setting call transfer for the first SIM card that functions as the secondary card after switching when the signal strength is no greater than the preset threshold.

In the second aspect, an embodiment of the present disclosure provides a non-transitory computer storage medium storing executable instructions that are configured to execute any one of the method for realizing automatic call transfer in a Dual SIM Dual Standby mobile phone according to the present disclosure.

In the third aspect, an embodiment of the present disclosure provides a device that includes: at least one processor; and a memory, wherein the memory stores instructions executable by the at least one processor, wherein the instructions are configured for executing any one of the above methods for realizing automatic call transfer in a Dual SIM Dual Standby mobile phone according to the present disclosure.

It may be seen from above that, in the method and the device for realizing automatic call transfer in a Dual SIM Dual Standby mobile phone according to the embodiments of the present disclosure, by monitoring a data storing process of a SIM card of a mobile phone during the operation of the mobile phone, acquiring the type of the first SIM card that functions as a main card currently when a trigger instruction for switching the data storage location is detected, acquiring a signal strength of a network supported by the current first SIM card functioning as a secondary card according to the type of the first SIM card, judging whether the signal strength of the network supported by the current first SIM card functioning as the secondary card is greater than a preset threshold, performing a data storage location switching operation, and setting call transfer for the first SIM card that functions as the secondary card after switching when the signal strength is no greater than the preset threshold, a process of automatically setting call transfer may be realized on a Dual SIM Dual Standby mobile phone, and user experience during the use of a Dual SIM Dual Standby mobile phone may be improved.

### BRIEF DESCRIPTION OF THE DRAWINGS

One or more embodiments are illustrated by way of example, and not by limitation, in the figures of the corresponding accompanying drawings, wherein elements having the same reference numeral designations represent like elements throughout. The drawings are not to scale, unless otherwise disclosed.

FIG. 1 is a schematic flow diagram of a method for realizing automatic call transfer in a Dual SIM Dual Standby mobile phone according to a first embodiment of the disclosure;

FIG. 2 is a schematic flow diagram of a method for realizing automatic call transfer in a Dual SIM Dual Standby mobile phone according to a reference embodiment of the disclosure;

FIG. 3 is a structural representation of a system for realizing automatic call transfer in a Dual SIM Dual Standby mobile phone according to the disclosure;

FIG. 4 is a structural representation of a system for realizing automatic call transfer in a Dual SIM Dual Standby mobile phone according to a reference embodiment of the disclosure; and

FIG. 5 is a diagram illustrating a corresponding hardware structure of a device on which a method for realizing automatic call transfer in a Dual SIM Dual Standby mobile phone according to a reference embodiment of the disclosure.

### DETAILED DESCRIPTION

In order to make the objects, technical solutions and advantages of the disclosure more apparent, the disclosure will be further illustrated in detail below in conjunction with specific embodiments and drawings.

In the current situation of the use of call transfer on a Dual SIM Dual Standby mobile phone, an automatic setting of call transfer function of a main card and a secondary card on the Dual SIM Dual Standby mobile phone cannot be realized according to the use demand of a user. As a result, when each user sets call transfer for the main card and the secondary card, he can only operate manually based on the requirement. In order to solve such a problem, the inventors realized, from the user's point of view, that a user hopes to automatically set call transfer for the main card and the secondary card when a Dual SIM Dual Standby mobile phone is used. Therefore, the concept of the disclosure lies in that a data storing process of a SIM card of a Dual SIM Dual Standby mobile phone is monitored for the Dual SIM Dual Standby mobile phone, and the data storage location will be switched and call transfer will be set when a trigger instruction for switching the data storage location is detected.

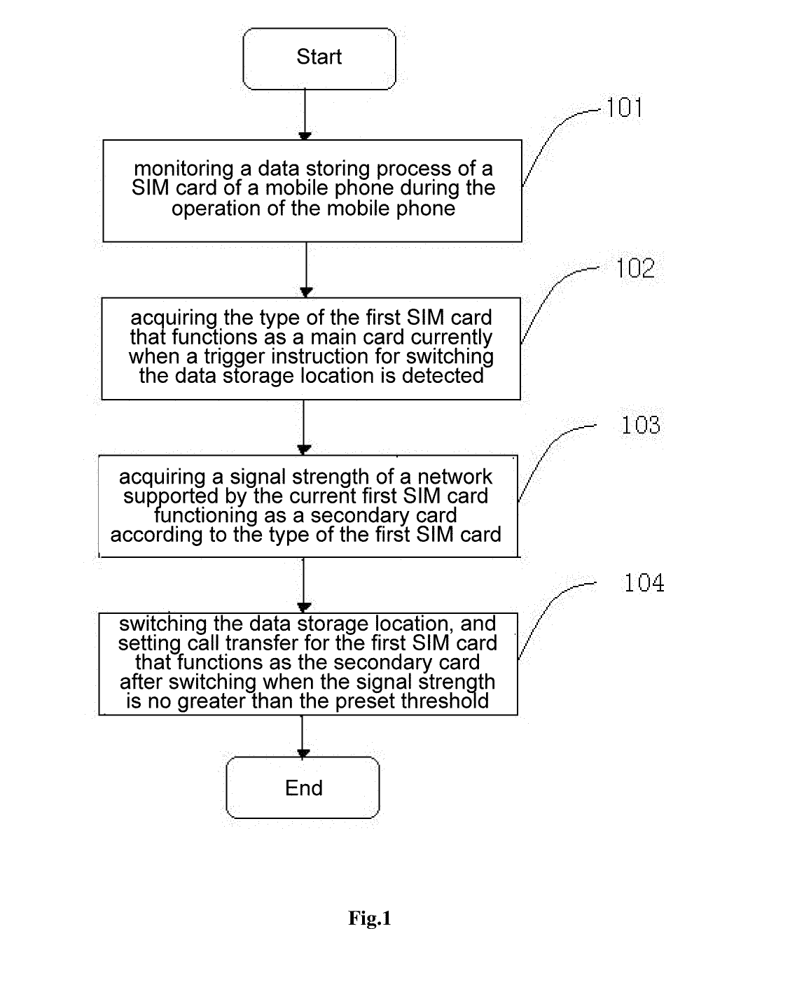

Referring to FIG. 1, it shows a schematic flow diagram of a method for realizing automatic call transfer in a Dual SIM Dual Standby mobile phone according to the first embodiment of the disclosure. The method includes:

In Step 101: a data storing process of a SIM card of a mobile phone is monitored during the operation of the mobile phone.

Preferably, during monitoring a data storing process of a SIM card of a mobile phone, the type of the first SIM card that functions as a main card currently may also be acquired, and the signal strength of a network supported by the first SIM card functioning as the main card may be monitored. Preferably, when it is monitored that the signal strength is no greater than a preset threshold, it judges whether the call transfer state of the first SIM card is open. If the call transfer state of the first SIM card is open, no operation will be performed; otherwise, the call transfer state of the first SIM card will be set as open. Therefore, in the disclosure, during the operation of the mobile phone, the signal strength of the network supported by the SIM card that functions as a main card currently may be monitored. Moreover, an automatic setting of the call transfer state of the SIM card that functions as the main card may be realized based on the network signal strength monitored.

In a more preferred embodiment, before setting the call transfer state of the SIM card that functions as the main card, it needs to judge whether the signal strength of the network supported by the first SIM card functioning as the main card is greater than a preset minimum threshold. If the signal strength is greater than the preset minimum threshold, the call transfer state of the first SIM card will be opened, and it will be set that a call transfer will be initiated under an unreachable state. If the signal strength is no greater than the preset minimum threshold, the call transfer state of the first SIM card will be opened, and an unconditional call transfer will be set.

In Step 102: the type of the first SIM card that functions as a main card currently is acquired when a trigger instruction for switching the data storage location is detected.

In one embodiment, when a user switches between the main card and the secondary card via a manual operation or when a user inserts and pulls out a SIM card, a switching of data storage location will occur on the Dual SIM Dual Standby mobile phone. Additionally, the type of the SIM card is generally determined by the operator, that is, China Mobile, China Unicom and China Telecom. For different SIM card types, the network types that are supported will be different. Moreover, the network types supported by the main card and the secondary card, which are consisted of different types of SIM cards respectively, will be different, as shown in the table below:

TABLE 1
Types of Networks That Support Voice Call

| Operator | Main card | Secondary Card |
|---|---|---|
| China Mobile | GSM, TD-SCDMA, LTE VoIP | GSM (2G) |
| | 4G/3G/2G, for short | |
| China Unicom | GSM, WCDMA, LTE VoIP | GSM (2G) |
| | 4G/3G/2G, for short | |
| China Telecom | CDMA 1x, LTE VoIP | No network will be |
| | | supported |

In Step 103: the signal strength of a network supported by the current first SIM card functioning as a secondary card is acquired according to the type of the first SIM card.

In one embodiment, according to the type of the first SIM card that functions as a main card currently, the signal strength value of the network supported by the main card that is set as the secondary card may be obtained by querying the dual mode supported by the MODEM protocol stack of the mobile phone.

In Step 104: it is judged whether the signal strength of the network supported by the current first SIM card functioning as the secondary card is greater than a preset threshold, and a data storage location switching operation is performed; further, a call transfer is set for the first SIM card that functions as the secondary card after switching when the signal strength is no greater than the preset threshold;

Among which, if the signal strength of the network supported by the current first SIM card functioning as the secondary card is greater than the preset threshold, the data storage location will be switched directly (that is, the main card and the secondary card will be exchanged). If the signal strength of a network supported by the current first SIM card functioning as a secondary card is no greater than the preset threshold, the data storage location will be switched (that is, the main card and the secondary card will be exchanged), and then a call transfer will be set (a setting of call transfer will be enabled) for the first SIM card that functions as the secondary card after switching (said SIM card functions as the main card before switching). Therefore, when the SIM cards for the main card and the secondary card are switched, an opening of the call transfer function for the SIM card that functions as the secondary card after switching may be realized. As a preferred embodiment, before opening the call transfer function, it is judged whether the signal strength of the network supported by the current SIM card functioning as the secondary card is greater than a preset minimum threshold, and if yes, a call transfer will be opened and it will be set that a call transfer will be initiated under an unreachable state; if no, a call transfer will be opened, and an unconditional call transfer will be set. Thereby, different types of call transfer may be set according to different network signal strengths.

As an embodiment, before switching the data storage location, the call transfer setting state of the second SIM card that functions as the secondary card currently may be acquired, and if it is determined that the setting state is closed, the data storage location will be switched directly; otherwise, the call transfer setting state of the second SIM card will be changed to a closed state, and then the data storage location will be changed. In this embodiment, for a SIM card that functions as a main card in a Dual SIM Dual Standby mobile phone, the signal strength of the network type supported by the SIM card is generally favorable, thus generally no call transfer needs to be set for the SIM card. Before the second SIM card that functions as the secondary card before switching is switched to the main card, if a call transfer is set, the call transfer function will be closed, and then the second SIM card will be switched as the main card.

In a preferred embodiment, after the type of the first SIM card that functions as a main card currently is acquired in Step 102, it may be judged whether there exists a network supported by the first SIM card functioning as a secondary card. Then, according to the judgement result, if there exists a supported network, it turns to Step 103 after Step 102 is performed, wherein in Step 103, the signal strength of a network supported by the current first SIM card functioning as a secondary card is acquired according to the type of the first SIM card. If there exists no network supported, it directly turns to Step 104 after Step 102 is performed, wherein in Step 104, the data storage location is switched, and call transfer is set for the first SIM card that functions as the secondary card after switching. For example, it is acquired that the type of the SIM card that functions as a main card currently is China Telecom, and no network is supported by the SIM card of China Telecom functioning as the secondary card, then the data storage location will be switched directly and call transfer is set for the China Telecom SIM card that functions as the secondary card after switching.

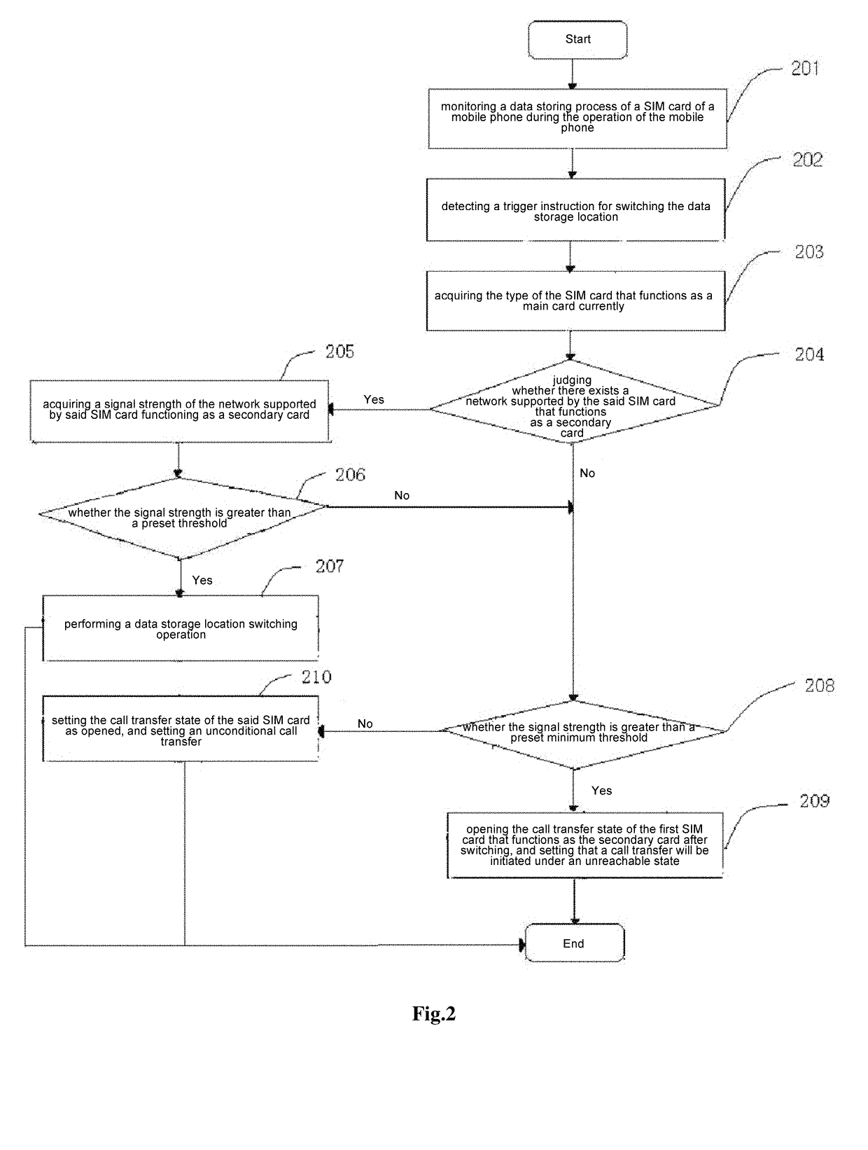

As a reference embodiment, referring to FIG. 2, a method for realizing automatic call transfer in a Dual SIM Dual Standby mobile phone may specifically include the steps of:

In Step 201: a data storing process of a SIM card of a mobile phone is monitored during the operation of the mobile phone;

In Step 202: a trigger instruction for switching the data storage location is detected;

In Step 203: the type of the first SIM card that functions as a main card currently is acquired;

In Step 204: it is judged whether there exists a network supported by the first SIM card that functions as a secondary card; if there exists a network supported, it is turned to Step 205; if there does not exist a supported network, it is turned to Step 208;

In Step 205: the signal strength of the network supported by the current first SIM card that functions as a secondary card is acquired according to the type of the first SIM card;

In Step 206: it is judged whether the signal strength of the network supported by the current first SIM card that functions as the secondary card is greater than a preset threshold; if the signal strength is greater than the preset threshold, it turns to Step 207; if the signal strength is no greater than the preset threshold, it turns to Step 208;

In Step 207: a data storage location switching operation is performed, and the process is ended;

In Step 208: a data storage location switching operation is performed, and it is judged whether the signal strength is greater than a preset minimum threshold; if yes, it turns to Step 209; otherwise, it turns to Step 210;

In Step 209: the call transfer state of the first SIM card that functions as the secondary card after switching is set as open, and it will be set that a call transfer will be initiated under an unreachable state;

In Step 210: the call transfer state of the said SIM card is set as opened, and an unconditional call transfer will be set.

As another reference embodiment, before the data storage location is switched in Step 207 and Step 208, the call transfer setting state of a second SIM card that functions as a secondary card currently may be acquired. If it is determined that the setting state is closed, the data storage location will be switched directly; otherwise, the call transfer setting state of a second SIM card that functions as a secondary card currently will be changed to closed, and then the data storage location will be switched.

It further needs to be noted that, during Step 201, the type of the first SIM card that functions as a main card currently may also be acquired, and the signal strength of a network supported by the first SIM card functioning as the main card may be detected. Preferably, when it is detected that the signal strength is no greater than the preset threshold, it judges whether the call transfer state of the first SIM card is open. If the call transfer state of the first SIM card is open, no operation will be performed; otherwise, the call transfer state of the SIM card will be set as open.

In a more preferred embodiment, before the call transfer state of the first SIM card functioning as the main card is set, it needs to judge whether the signal strength of the network supported by the first SIM card functioning as the main card is greater than a preset minimum threshold. If the signal strength is greater than the preset minimum threshold, the call transfer state of the first SIM card will be opened, and it will be set that a call transfer will be initiated under an unreachable state. If the signal strength is no greater than the preset minimum threshold, the call transfer state of the first SIM card will be opened, and an unconditional call transfer will be set.

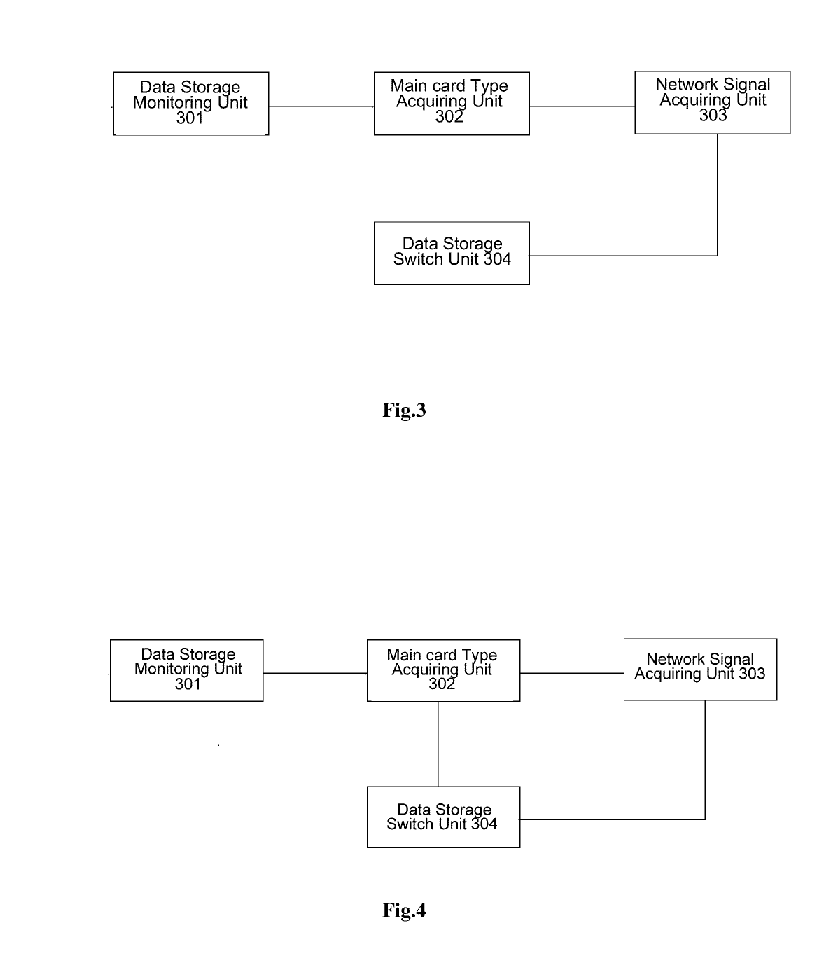

In another aspect of the disclosure, there further provides a system for realizing automatic call transfer in a Dual SIM Dual Standby mobile phone. As shown in FIG. 3, the system for realizing automatic call transfer in a Dual SIM Dual Standby mobile phone includes the following components that are connected in turn: a data storage monitoring unit 301, configured for monitoring a data storing process of a SIM card of a mobile phone during the operation of the mobile phone; a main card type acquiring unit 302, configured for acquiring the type of the first SIM card that functions as a main card currently while a trigger instruction for switching the data storage location is monitored; a network signal acquiring unit 303, configured for acquiring the signal strength of a network supported by the current first SIM card functioning as a secondary card according to the type of the first SIM card; and a data storage switch unit 304, configured for judging whether the signal strength of the network supported by the current first SIM card functioning as the secondary card is greater than a preset threshold, performing a data storage location switching operation, and setting call transfer for the first SIM card that functions as the secondary card after switching when the signal strength is no greater than the preset threshold.

Preferably, during monitoring a data storing process of a SIM card of a mobile phone, the data storage monitoring unit 301 may also acquire the type of the first SIM card that functions as a main card currently, and monitor the signal strength of a network supported by the first SIM card functioning as the main card. Preferably, when it is monitored that the signal strength is no greater than a preset threshold, it judges whether the call transfer state of the first SIM card is open. If the call transfer state of the first SIM card is open, no operation will be performed; otherwise, the call transfer state of the first SIM card will be set as open. Therefore, in the disclosure, during the operation of the mobile phone, the signal strength of the network supported by the SIM card that functions as a main card currently may be monitored. Moreover, an automatic setting of the call transfer state of the SIM card that functions as the main card may be realized based on the network signal strength monitored.

In a more preferred embodiment, before setting the call transfer state of the first SIM card that functions as the main card, the data storage monitoring unit 301 needs to judge whether the signal strength of the network supported by the first SIM card functioning as the main card is greater than a preset minimum threshold. If the signal strength is greater than the preset minimum threshold, the call transfer state of the first SIM card will be opened, and it will be set that a call transfer will be initiated under an unreachable state. If the signal strength is no greater than the preset minimum threshold, the call transfer state of the first SIM card will be opened, and an unconditional call transfer will be set.

As a reference embodiment, the data storage switch unit 304 judges whether the signal strength of the network supported by the current first SIM card functioning as the secondary card is greater than a preset threshold; if the signal strength of the network supported by the current first SIM card functioning as the secondary card is greater than the preset threshold, the data storage location will be switched directly (that is, the main card and the secondary card will be exchanged). If the signal strength of a network supported by the current first SIM card functioning as a secondary card is no greater than the preset threshold, the data storage location will be switched (that is, the main card and the secondary card will be exchanged), and then a call transfer will be set (a setting of call transfer will be enabled) for the first SIM card that functions as the secondary card after switching (said SIM card functions as the main card before switching). Therefore, when the SIM cards for the main card and the secondary card are switched, an opening of the call transfer function for the SIM card that functions as the secondary card after switching may be realized. As a preferred embodiment, before opening the call transfer function, it is judged whether the signal strength of the network supported by the current SIM card functioning as the secondary card is greater than a preset minimum threshold, and if yes, a call transfer will be opened and it will be set that a call transfer will be initiated under an unreachable state; if no, a call transfer will be opened, and an unconditional call transfer will be set. Thereby, different types of call transfer may be set according to different network signal strengths.

Additionally, before switching the data storage location, the data storage switch unit 304 may acquire the call transfer setting state of a second SIM card that functions as a secondary card currently, and if it is determined that the setting state is closed, the data storage location will be switched directly; otherwise, the call transfer setting state of a second SIM card that functions as a secondary card currently will be changed to closed, and then the data storage location will be switched.

As another reference embodiment, as shown in FIG. 4, after acquiring the type of the first SIM card that functions as a main card currently, the main card type acquiring unit 302 may judge whether there exists a network supported by the first SIM card functioning as a secondary card. Then, according to the judgement result, if there exists a supported network, the main card type acquiring unit 302 will be connected with the network signal acquiring unit 303, and the network signal acquiring unit 303 continues to perform operation. If there does not exist a network supported, the main card type acquiring unit 302 will be connected with the data storage switch unit 304, and the data storage switch unit 304 will switch the data storage location directly and set call transfer for the first SIM card that functions as the secondary card after switching.

One embodiment of the present disclosure further provides a non-transitory computer storage medium, on which a program is stored; when executed, the program may realize part of or all of the steps in each implementation mode of the method for realizing automatic call transfer in a Dual SIM Dual Standby mobile phone as shown in FIG. 1 and FIG. 2.

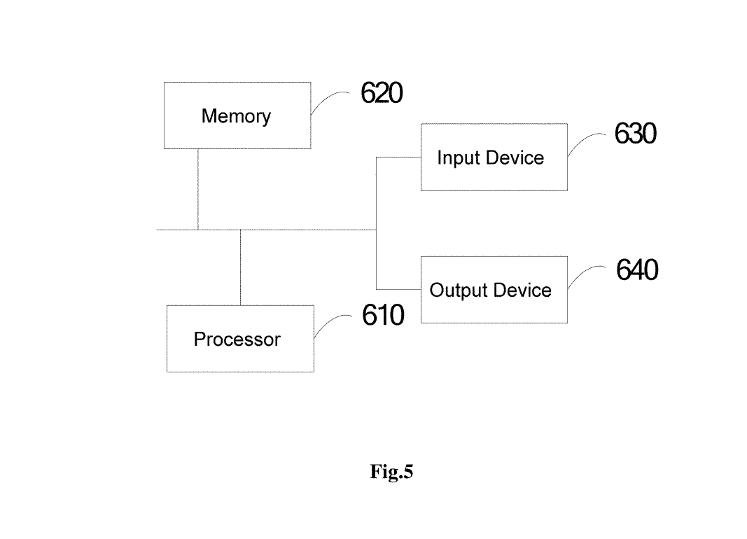

FIG. 5 is a diagram illustrating a hardware structure of a mobile phone on which a method for realizing automatic call transfer in a Dual SIM Dual Standby mobile phone provided by an embodiment of the present disclosure. As shown in FIG. 5, the device includes:

at least one processor 610 and a memory 620, wherein only one processor 610 is illustratively shown in FIG. 5.

The device may also include: an input device 630 and an output device 640.

The processor 610, memory 620, input device 630 and output device 640 may be connected via a bus or other means, wherein a connecting bus is illustratively shown in FIG. 5.

The memory 620, as a non-volatile computer readable storage medium, may be used to store non-volatile software programs, non-volatile computer executable programs and modules, such as the program commands/modules corresponded to the method for realizing automatic call transfer in a Dual SIM Dual Standby mobile phone according to the embodiments in the present disclosure (for example, a data storage monitoring unit 301, a main card type acquiring unit 302, a network signal acquiring unit 303, and a data storage switch unit 304 as illustrated in FIG. 3). The processor 610, by running non-volatile software programs, commands and modules stored in the memory 620, performs various functional applications and data processing of the server, i.e., carries out the method for realizing automatic call transfer in a Dual SIM Dual Standby mobile phone according to above method embodiments.

The memory 620 may include a program storage area and a data storage area, wherein the program storage area may be used to store application programs needed by an operating system or by at least one function, and the data storage area may be used to store data created by running the device for amplifying a video image, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the device for amplifying a video image via a network connection. An example of such a network includes, but not limited to, internet, intranet, local area network, mobile communication network, and a combination thereof.

The input device 630 may receive input digital or character information, and generate key signal inputs concerned with user setting and functional control of the system for realizing automatic call transfer in a Dual SIM Dual Standby mobile phone. The output device 640 may include displaying means such as a display screen.

The at least one module is stored in the memory 620, and, when run by the at least one processor 610, executes the method for realizing automatic call transfer in a Dual SIM Dual Standby mobile phone according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The devices of the embodiments of the present disclosure exists in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, and includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for realizing automatic call transfer in a Dual SIM Dual Standby mobile phone applied to a device, comprising the steps of:
monitoring a data storing process of a SIM card of a mobile phone during the operation of the mobile phone;
acquiring the type of the first SIM card that functions as a main card currently when a trigger instruction for switching the data storage location is detected;
acquiring a signal strength of a network supported by the current first SIM card functioning as a secondary card according to the type of the first SIM card; and
judging whether the signal strength of the network supported by the current first SIM card functioning as the secondary card is greater than a preset threshold, performing a data storage location switching operation, and setting call transfer for the first SIM card that functions as the secondary card after switching when the signal strength is no greater than the preset threshold.

2. The method according to claim 1, wherein, after the step of acquiring the type of the first SIM card that functions as a main card currently, the method further comprises:
judging whether there exists a network supported by the first SIM card functioning as a secondary card; and
according to the judgement result, if there exists a supported network, acquiring the signal strength of the network supported by the current first SIM card functioning as the secondary card according to the type of the first SIM card; if there does not exist a supported network, switching the data storage location directly and setting call transfer for the first SIM card that functions as the secondary card after switching.

3. The method according to claim 2, wherein, before the step of switching the data storage location, the method further comprises:
acquiring a call transfer setting state of a second SIM card that functions as a secondary card currently; and
switching the data storage location directly if it is determined that the setting state is closed; otherwise, changing the call transfer setting state of the second SIM card to be closed, and then switching the data storage location.

4. The method according to claim 1, wherein, during the monitoring of the data storing process of the mobile phone, the method further comprises:
acquiring the type of the first SIM card that functions as a main card currently, and monitoring the signal strength of a network supported by the first SIM card functioning as the main card;
judging whether the call transfer state of the first SIM card is open when it is detected that the signal strength is no greater than a preset threshold; and
according to the judgement result, performing no operation if the call transfer state of the first SIM card is open; otherwise, setting the call transfer state of the first SIM card as open.

5. The method according to claim 4, wherein, before the step of setting the call transfer state of the first SIM card as open, the method further comprises:
judging whether the signal strength is greater than a preset minimum threshold; and
according to the judgement result, if the signal strength is greater than the preset minimum threshold, opening the call transfer state of the first SIM card and setting that a call transfer will be initiated under an unreachable state; if the signal strength is no greater than the preset minimum threshold, opening the call transfer state of the first SIM card and setting an unconditional call transfer.

6. A non-transitory computer storage medium storing executable instructions that are configured to:
monitor a data storing process of a SIM card of a mobile phone during the operation of the mobile phone;
acquire the type of the first SIM card that functions as a main card currently when a trigger instruction for switching the data storage location is detected;
acquire a signal strength of a network supported by the current first SIM card functioning as a secondary card according to the type of the first SIM card; and
judge whether the signal strength of the network supported by the current first SIM card functioning as the secondary card is greater than a preset threshold, perform a data storage location switching operation, and set call transfer for the first SIM card that functions as the secondary card after switching when the signal strength is no greater than the preset threshold.

7. The non-transitory computer storage medium according to claim 6, wherein the executable instructions are further configured to:
judge whether there exists a network supported by the first SIM card functioning as a secondary card; and
according to the judgement result, if there exists a supported network, acquire the signal strength of the network supported by the current first SIM card functioning as the secondary card according to the type of the first SIM card; if there does not exist a supported network, switch the data storage location directly and set call transfer for the first SIM card that functions as the secondary card after switching.

8. The non-transitory computer storage medium according to claim 7, wherein the executable instructions are further configured to:
acquire a call transfer setting state of a second SIM card that functions as a secondary card currently; and
switch the data storage location directly if it is determined that the setting state is closed; otherwise, change the call transfer setting state of the second SIM card to be closed, and then switch the data storage location.

9. The non-transitory computer storage medium according to claim 6, wherein the executable instructions are further configured to:
acquire the type of the first SIM card that functions as a main card currently, and monitor the signal strength of a network supported by the first SIM card functioning as the main card;
judge whether the call transfer state of the first SIM card is open when it is detected that the signal strength is no greater than a preset threshold; and
according to the judgement result, perform no operation if the call transfer state of the first SIM card is open; otherwise, set the call transfer state of the first SIM card as open.

10. The non-transitory computer storage medium according to claim 9, wherein the executable instructions are further configured to:
judge whether the signal strength is greater than a preset minimum threshold; and
according to the judgement result, if the signal strength is greater than the preset minimum threshold, open the call transfer state of the first SIM card and set that a call transfer will be initiated under an unreachable state; if the signal strength is no greater than the preset minimum threshold, open the call transfer state of the first SIM card and set an unconditional call transfer.

11. A device comprising
at least one processor; and
a memory for storing instructions executable by the at least one processor,
wherein the at least one processor is configured to:
monitor a data storing process of a SIM card of a mobile phone during the operation of the mobile phone;
acquire the type of the first SIM card that functions as a main card currently when a trigger instruction for switching the data storage location is detected;
acquire a signal strength of a network supported by the current first SIM card functioning as a secondary card according to the type of the first SIM card; and
judge whether the signal strength of the network supported by the current first SIM card functioning as the secondary card is greater than a preset threshold, perform a data storage location switching operation, and set call transfer for the first SIM card that functions as the secondary card after switching when the signal strength is no greater than the preset threshold.

12. The device according to claim 11, wherein after the at least one processor executes the step to acquire the type of the first SIM card that functions as a main card currently, the at least one processor is further configured to:
judge whether there exists a network supported by the first SIM card functioning as a secondary card; and
according to the judgement result, if there exists a supported network, acquire the signal strength of the network supported by the current first SIM card functioning as the secondary card according to the type of the first SIM card; if there does not exist a supported network, switch the data storage location directly and set call transfer for the first SIM card that functions as the secondary card after switching.

13. The device according to claim 12, wherein before the at least one processor executes the step to switch the data storage location, the at least one processor is further configured to:
acquire a call transfer setting state of a second SIM card that functions as a secondary card currently; and
switch the data storage location directly if it is determined that the setting state is closed; otherwise, change the call transfer setting state of the second SIM card to be closed, and then switch the data storage location.

14. The device according to claim 11, wherein during the at least one processor executes the step to monitor of the data storing process of the mobile phone, the at least one processor is further configured to:
acquire the type of the first SIM card that functions as a main card currently, and monitor the signal strength of a network supported by the first SIM card functioning as the main card;
judge whether the call transfer state of the first SIM card is open when it is detected that the signal strength is no greater than a preset threshold; and
according to the judgement result, perform no operation if the call transfer state of the first SIM card is open; otherwise, set the call transfer state of the first SIM card as open.

15. The device according to claim 14, wherein before the at least one processor executes the step to set the call transfer state of the first SIM card as open, the at least one processor is further configured to:
judge whether the signal strength is greater than a preset minimum threshold; and
according to the judgement result, if the signal strength is greater than the preset minimum threshold, open the call transfer state of the first SIM card and set that a call transfer will be initiated under an unreachable state; if the signal strength is no greater than the preset minimum threshold, open the call transfer state of the first SIM card and set an unconditional call transfer.
